(19) United States
(12) Patent Application Publication
(10) Pub. No.: US 2013/0318871 A1
(43) Pub. Date: Dec. 5, 2013

(54) PLANTER HAVING A MULTI-PURPOSE LID

(71) Applicant: Eco Box Holdings, LLC, Deerfield Beach, FL (US)

(72) Inventors: Linda Street, Boca Raton, FL (US); Brian Street, Boca Raton, FL (US)

(73) Assignee: Eco Box Holdings, LLC, Deerfield Beach, FL (US)

(21) Appl. No.: 13/909,740

(22) Filed: Jun. 4, 2013

Related U.S. Application Data
(60) Provisional application No. 61/655,254, filed on Jun. 4, 2012.

(51) Int. Cl. A01G 9/02; A01G 1/00

(52) U.S. Cl. CPC A01G 9/021; A01G 9/02; A01G 1/001
USPC 47/65.7; 47/65.5; 47/66.7

(57) ABSTRACT

A planter includes a lid and a container. The container has an upper side, a lower side, and a plurality of lateral walls extending between the upper side and lower side. The upper side, lower side, and lateral walls of the container define a container interior configured to retain a growth medium. The upper side of the container includes an opening configured to provide access to the container interior, and the lower side includes a plurality of drainage apertures or holes. One or more protrusions extend from at least one of an first face of the lid and the exterior of the lower side of the container.

### CROSS-REFERENCE TO RELATED APPLICATION

This application claims priority to Provisional Application No. 61/655,254, filed Jun. 4, 2012, which is herein incorporated by reference in its entirety.

### TECHNICAL FIELD

The present disclosure relates to systems for plant cultivation. More specifically, the present disclosure relates to a planter used for germinating seeds and growing plants.

### BACKGROUND

Plants that are grown from seeds often require a variety of supplies. Plants and seeds are generally sold separately from the supplies needed to sprout the seeds and grow the plants. The required supplies generally include soil, fertilizer, and a container for growing the plants. These supplies are often sold in quantities that are much larger than what is needed by someone who is interested in growing one to several plants indoors. Also, the supplies may change depending on the type of plant that is grown, thus requiring a person to potentially acquire multiple types of soils, containers, and fertilizers when growing more than one type of plant. Additional supplies may be desired to provide seeds with adequate growing conditions, such as heat, moisture, and lighting. Examples of these additional supplies can include such as lighting fixtures and/or containers for creating a greenhouse-type environment. Once supplies are obtained, potting seeds into appropriate containers with the proper amount of soil and the appropriate fertilizer can be time-consuming and create a mess. There is a need for an easier and more convenient option for a person to grow one or more particular plants from seeds within an indoor environment.

In addition, the containers used to grow seeds and plants are commonly made from plastic materials that add waste to the environment. Consumers may desire the option to use recycled, recyclable, and/or sustainable materials since indoor planting can involve multiple plastic containers and accessory components. There is a need to provide a less wasteful option for growing plants indoors.

### SUMMARY

Disclosed herein are embodiments of a planter including a lid and a container with a removable seal configured to germinate seeds and to grow plants in an indoor environment.

In Example 1, a planter includes a lid and a container. The container has an upper side, a lower side, and a plurality of lateral walls extending between the upper side and lower side. The upper side, lower side, and lateral walls of the container define a container interior configured to retain a growth medium. The upper side of the container includes an opening configured to provide access to the container interior, and the lower side includes a plurality of drainage apertures or holes. One or more protrusions extend from either a first face of the lid or an exterior of the lower side of the container. In a pre-use configuration, the lid is couplable to the upper side of the container to cover the opening such that the lid prevents egress of any contents from the container interior. In a drip tray configuration, the lid is couplable to the lower side of the container such that the one or more protrusions separate the plurality of drainage apertures from the lid to allow egress of liquid from the container interior onto the lid.

In Example 2, the planter according to Example 1, wherein, in a greenhouse configuration, an inverted lid is couplable to the upper side of the container to cover the opening such that the lid creates a greenhouse effect for sprouting seeds.

In Example 3, the planter according to either Example 1 or 2, wherein a portion of the container includes a recycled or recyclable plastic material.

In Example 4, the planter according to any of Examples 1-3, wherein at least approximately 50% of the container includes a recycled or recyclable plastic material.

In Example 5, the planter according to any of Examples 1-4, wherein the upper side and/or the lower side of the container is a substantially rectangular-shaped.

In Example 6, the planter according to any of Examples 1-5, wherein the upper side and/or the lower side of the container is substantially square-shaped.

In Example 7, the planter according to any of Examples 1-6, wherein the diameter of the one or more holes ranges from approximately 0.125″ to approximately 0.750″.

In Example 8, the planter according to any of Examples 1-7, further comprising a removable sealing element coupled to the exterior of the lower side of the container such that the plurality of drainage apertures are covered and the removable sealing element prevents egress of any contents from the container interior.

In Example 9, the planter according to any of Examples 1-8, wherein the removable sealing element is an adhesive sheet.

In Example 10, the planter according to any of Examples 1-9, wherein a portion of the lid includes a recycled or recyclable plastic material.

In Example 11, the planter according to any of Examples 1-10, wherein at least approximately 30% of the lid includes a recycled or recyclable plastic material.

In Example 12, the planter according to any of Examples 1-11, wherein the lid is made of a light-permeable material.

In Example 13, the planter according to any of Examples 1-12, wherein the lid is configured to have an interference and sealing fit with the upper side of the container.

In Example 14, the planter according to any of Examples 1-13, wherein the container is configured to retain pre-seeded growth medium in the form of a plant disk.

In Example 15 is a method for using a planter that has a light-permeable lid, and a container. The container has an upper side, a lower side, and a plurality of lateral walls extending between the upper side and lower side. The upper side, lower side, and lateral walls define a container interior that contains pre-seeded growth medium. The upper side includes an opening configured to provide access the container interior and the lower side includes a plurality of drainage apertures. One or more protrusions extend from a first face of the lid or an exterior or the lower side of the container.

In use, the lid is removed and the pre-seeded growth medium is moistened with a predetermined amount of liquid. The lid positioned into an inverted orientation and placed on top of the container. The planter is placed in a light exposed area. After plants sprout to a predetermined height, the lid is removed from the container. The method further includes coupling the first face of the lid to the lower side of the container, wherein one or more protrusions on the lid and/or container separate the plurality of drainage apertures from the lid to allow egress of liquid from the container interior onto the lid. The pre-seeded growth medium is watered periodically until the plants reach maturity.

In Example 16, the method according to Example 15, wherein the plants begin to sprout to the predetermined height of about 1 inch to about 1½ inches.

In Example 17, the method according to either Example 15 or 16, wherein the container further including a removable sealing element coupled to an exterior of the lower side such that the plurality of drainage apertures are covered. The method for using the planter further comprising removing the removable sealing element from a lower side of a container after plants sprout to the predetermined height.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a perspective view of an embodiment of a planter in a pre-use configuration, according to the present disclosure.

FIG. 2 is a top perspective view of an embodiment of the planter in a greenhouse configuration.

FIG. 3 is another perspective view of an embodiment of the planter in a drip tray configuration.

FIG. 4 is a top view of an embodiment of a container portion of the planter.

FIG. 5 is a side view of an embodiment of the container portion of the planter.

FIG. 6 is a plan view of an embodiment of a lid portion of the planter.

FIG. 7 is a side view of an embodiment of the lid portion of the planter.

FIG. 8 is a flow chart of a method for using the planter illustrated in FIGS. 1-7.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

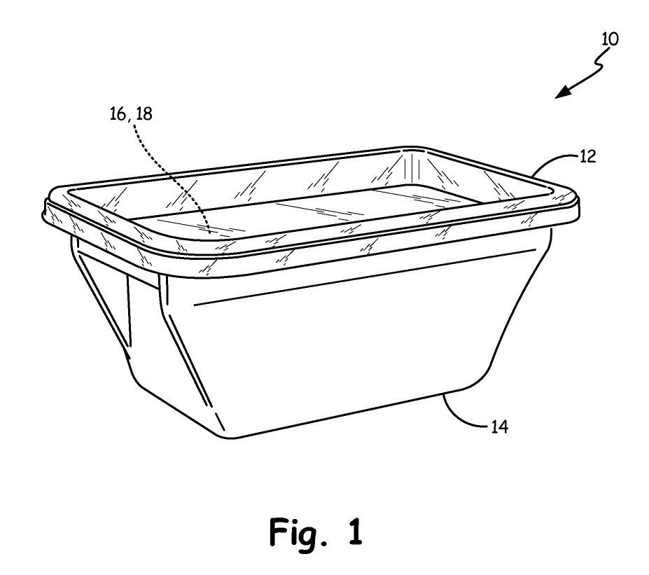

FIG. 1 is a perspective view of an embodiment of a planter 10, according to the present disclosure. The planter 10 includes a lid 12 and a container 14 that can be filled with a growth medium 16 and plant seeds 18. The lid 12 and container 14 can be assembled to create one or more planter configurations. The planter 10 can be configured for transportation or for creating a greenhouse environment while the seeds are germinating. Alternatively, the planter 10 can be configured for regular watering and for growing plants. The planter 10 is an indoor planting system that may be used for germinating seeds 18 and growing plants.

As shown in FIG. 1, the lid 12 can serve as a cover for the container 14 to retain the plant growth medium 16 prior to use, for example, during shipping or storage. The lid 12 may fit within the container compartment by partially depressing into the top portions of the container 14. In some embodiments, the pre-use configuration allows the lid 12 to minimize the overall product size during distribution and sales. Also, the lid 12 may be used to firmly pack and secure growth medium 16 and plant seeds 18 inside the container 14 during shipment.

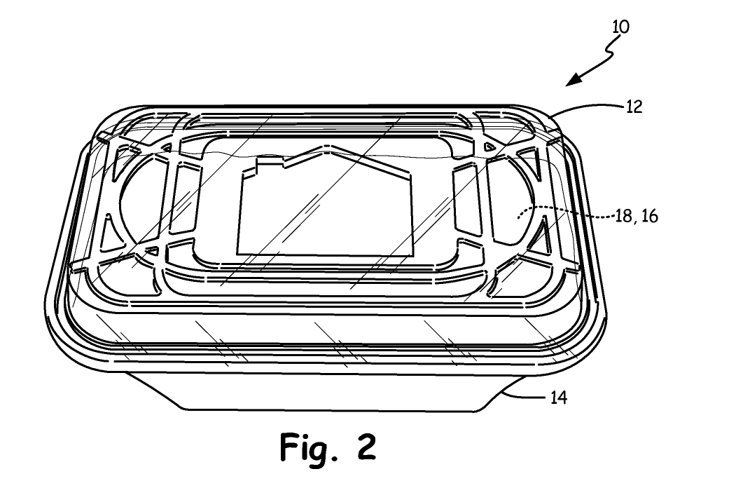

FIG. 2 is a perspective view of an embodiment of the planter 10 shown in a greenhouse configuration. In this configuration, the lid 12 is inverted relative to the lid orientation in the pre-use configuration and placed on top of the container 14. The planter 10 can function as a greenhouse environment for the seeds 18 inside the container 14 when the light-permeable lid 12 is placed over the container 14.

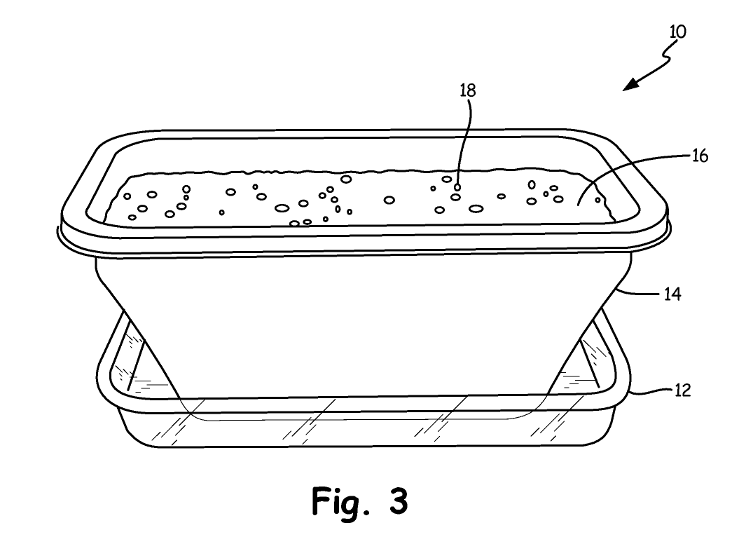

FIG. 3 is a perspective view of an embodiment of the planter 10 in a drip-tray configuration. As shown in this figure, the lid 12 is inverted relative to the lid orientation in the greenhouse configuration and placed on bottom of the container 14. The container 14 is configured to be filled with growth medium 16 and seeds 18 for growing plants and the lid 12 functions as a drip tray for the planter 10 when it is placed under the container 14.

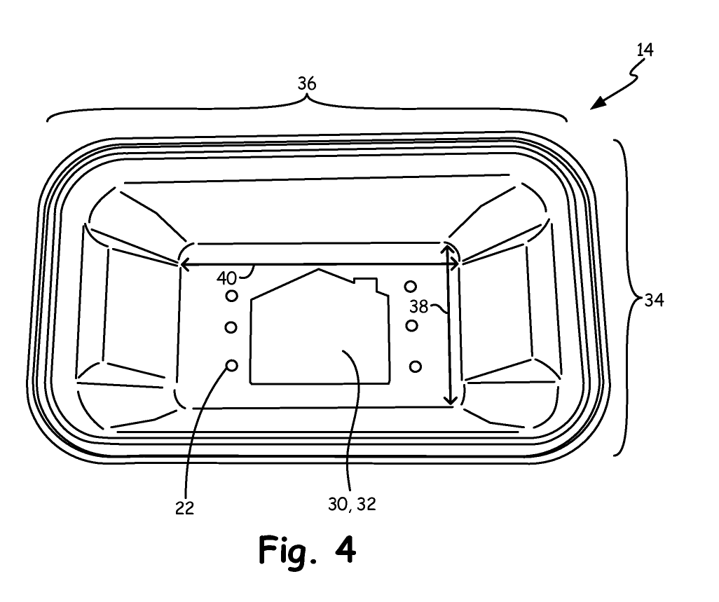

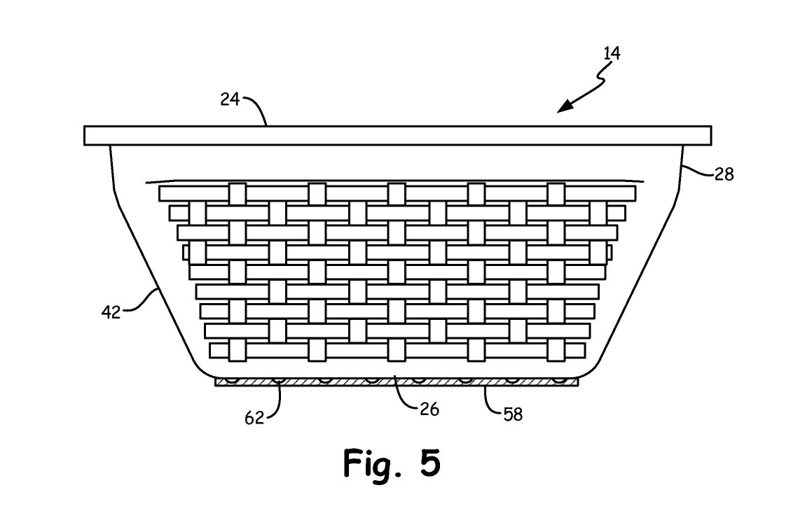

FIG. 4 is a top view and FIG. 5 is a side view of an embodiment of the container 14. As shown in this embodiment, the container 14 has an upper side 24, a lower side 26, and a plurality of lateral walls 28 extending between the upper side 24 and lower side 26. The upper side 24, lower side 26, and lateral walls 28 define a container interior 30 configured to retain a growth medium 16 and plant seeds 18. The upper side 24 includes an opening 32 configured to provide access the container interior 30, and the lower side 26 includes a plurality of drainage apertures or holes 22. In some embodiments, the lower side 26 of the container 14 includes one or more drainage holes 22, wherein each drainage hole 22 diameter ranges from approximately 0.125″ to approximately 0.750″. In various embodiments, the width 34 and length 36 of the upper side 24 are slightly larger than the width 38 and the length 40 of the lower side 26 such that the lateral walls 28 are tapered 42 from the upper side 24 to the lower side 26. In some embodiments, the container 14 can include one or more container protrusions 62 extending from an exterior surface of the lower side 26 of the container 14. Examples of container protrusions include, but are not limited to, corrugated ridges, raised dimples, and/or embossed ornamental designs or company logo extending from the lower side 26. The container protrusions 62 on the exterior of the lower side 26 can facilitate the drainage of water from the container 14 onto the lid 12.

In various embodiments, the planter 10 can include at least one removable sealing element 58 coupled to an exterior of the lower side 26 such that the plurality of drainage holes 22 are covered. In various embodiments, the removable sealing element 58 comprises a non-water-soluble material, for example, vinyl, polyester, polyester, or polypropylene. Examples of a removable sealing element 58 include, though not limited to, non-water-soluble adhesive labels.

In various embodiments, a portion of the container 14 is comprised of a non-water-absorbing plastic material that made of one of a recycled or recyclable material. For example, in some of these embodiments, at least approximately 50% of the container 14 may comprise one of a recycled or recyclable plastic material. In some embodiments, the container 14 can be made of a material that is translucent, opaque, or a combination thereof. Examples of materials that can be used for the container 14 include, but are not limited to, recycled and/or recyclable polyethylene terephthalate (PET, PETE), high-density polyethylene (HDPE), polyvinyl chloride (PVC), low-density polyethylene (LDPE), polypropylene (PP), polystyrene (PS), polycarbonate (PC), and acrylonitrile butadiene styrene (ABS). In other embodiments, a portion of the container 14 is comprised of a biodegradable material, for example, a biodegradable wax-coated cardboard.

In various embodiments, the container 14 includes a color and/or graphics. In some embodiments, the container 14 can include a single color design or a multicolor design. In other embodiments, the container 14 can include graphics, for example, molded textures, molded imprints, and an ink-printed or laser-printed image, such as a terra cotta or a natural stone appearance. In some embodiments, the graphics 14 may include information that includes, but is not limited to, the name of the distributor and/or manufacturer, a logo, a trademark, a domain name, and/or the product name.

In various embodiments, the container 14 can be configured to retain growth medium 16 and plant seeds 18. In some embodiments, the container 14 can be configured to retain growth medium 16 that has been pre-seeded, for example, the pre-seeded growth medium 16 may be formed into a plant disk. The plant disk is a wafer comprising water soluble plant growth medium 16 and seeds 18 of a predetermined plant species. In some of these embodiments, the container 14 can be configured to retain between two and ten 6″ by 6″ plant disks. For example, a 6″ by 12″ container 14 can be configured to retain two plant disks side-by-side whereas a 12″ by 12″ container 14 can be configured to retain four plant disks arranged in a square configuration. The seeds 18 of the plant species arranged in the plant disk can include fruits, vegetables, herbs, and flowers. In some embodiments, the container 14 can be pre-packed with a growth medium 16 and plant seeds 18, while in other embodiments the container 14 can be configured to hold a growth medium 16 and plant seeds 18 without being pre-packed.

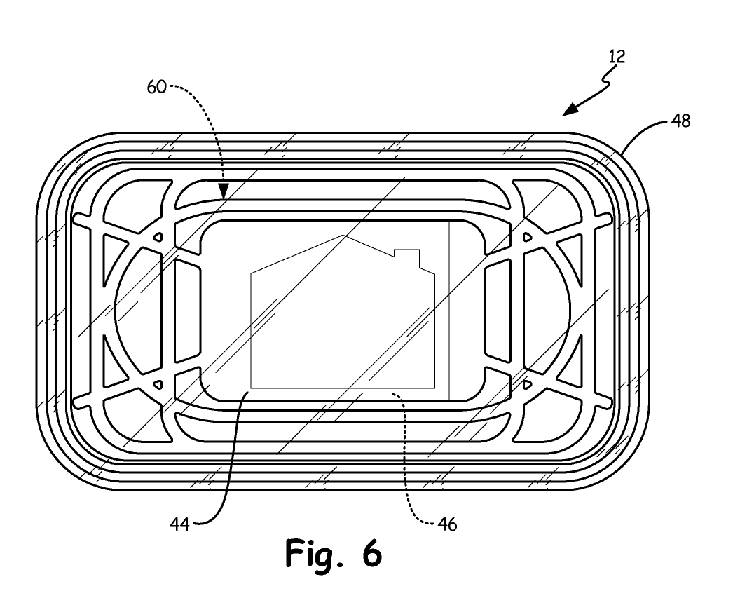

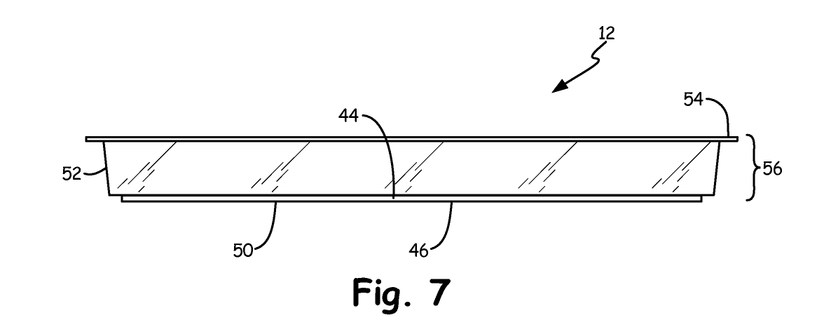

FIG. 6 is a top view and FIG. 7 is a side view of an embodiment of the lid 12. In the embodiments shown in FIGS. 5 and 6, the lid 12 has a first face 44 and a second face 46. The faces 44, 46 of the lid 12 are shown in these figures to be substantially rectangular-shaped with rounded edges 48. In other embodiments, however, the first and second faces 44, 46 of the lid 12 can have different forms, for example, a square shape or a circular shape with a peripheral upstanding wall. As shown in FIG. 7, the lid 12 is formed with a generally planar depressed face section 50 which merges with an upwardly inclined wall section 52 joined to the outer rim 54 of the lid 12. The depressed face section 50 and wall section 52 are configured to fit within the interior 30 of the container 14. In some embodiments, the height 56 from the depressed face section 50 and the outer rim 54 can range from approximately 0.5 inch to approximately 2 inches. The outer rim 54 of the lid 12 is configured to fit over the upper side 24 of the container 14. In some embodiments, the outer rim 54 of the lid 12 can be further configured to have an interference and sealing fit with the upper side 24 of the container 14.

In some embodiments, the lid 12 can include one or more lid protrusions 60 from the first face 44 of the lid 12. Examples of lid protrusions 60 include, but are not limited to, corrugated ridges or raised dimples extending from the first face 44. The corrugated ridges on the lid 12 can facilitate the drainage of water from the container 14. As shown in FIG. 7, the lid 12 can include a design and/or advertising information on either the first or second face 44, 46. In some embodiments, the design and advertising information is pre-molded, ink-printed, laser-printed to one of the faces or includes on an adhesive label adhered to one of the faces. In some of these embodiments, the design and advertising information may use one or more lid protrusions 60 for at least a portion of the design. The design and/or advertising information may include, but is not limited to, the name of the distributor and/or manufacturer, a logo, a domain name, a trademark, and the product name.

In various embodiments, at least a portion of lid 12 is made of a light-permeable and non-water absorbing material. In some embodiments, a portion of the lid 12 may comprise a recycled and/or recyclable plastic material. For example, in some of these embodiments, at least approximately 30% of the lid 12 comprises one of a recycled or recyclable plastic material. Examples of materials that are suitable for constructing the lid 12 include, but are not limited to, recycled and/or recyclable polyethylene terephthalate (PET, PETE), high-density polyethylene (HDPE), polyvinyl chloride (PVC), low-density polyethylene (LDPE), polypropylene (PP), polystyrene (PS), polycarbonate (PC), and acrylonitrile butadiene styrene (ABS). In other embodiments, a portion of the container 14 can comprise a biodegradable, non-water absorbing material, for example, a biodegradable wax-coated cardboard material. By using a non-water absorbing and light-permeable material, the lid 12 can retain water collected when used as a drip tray and the lid 12 can create a greenhouse effect during seed germination.

In various embodiments, the planter 10 can have multiple configurations for serving different functions. In some of these embodiments, the planter 10 can have three different configurations: the pre-use, greenhouse, and drip tray configuration. The pre-use configuration can be used for securing growth medium 16 and seeds 18 inside the planter 10 during product distribution and sales. In this configuration, the lid 12 is coupled to the upper side 24 of the container 14 to cover the opening 32 such that the second face 46 of the lid 12 faces the interior of the container 14. Also, the planter 10 may include the removable sealing element 58 to prevent egress of any contents from the container interior 30 for a predetermined duration.

The greenhouse configuration may be used to provide a greenhouse environment for sprouting seeds 18. In this configuration, the lid 12 is positioned is coupled to the upper side 24 of the container 14 with the first face 44 directed toward the growth medium to maximize the enclosed space within the planter 10.

The drip-tray configuration can be used to grow plants in a planter 10 having a drip tray to collect any excess fluid flowing out of the container drainage holes 22. In this configuration, the removable sealing element 58, if present, is removed and the lid 12 is placed under the lower side 26 of the container 14 such that the second face 46 abuts the lower side 26. Also, one or more protrusions 60, 62 of the lid 12 and/or the container 14 separate the plurality of drainage holes 22 from the lid 12 to allow egress of liquid from the container interior 30 onto the lid 12.

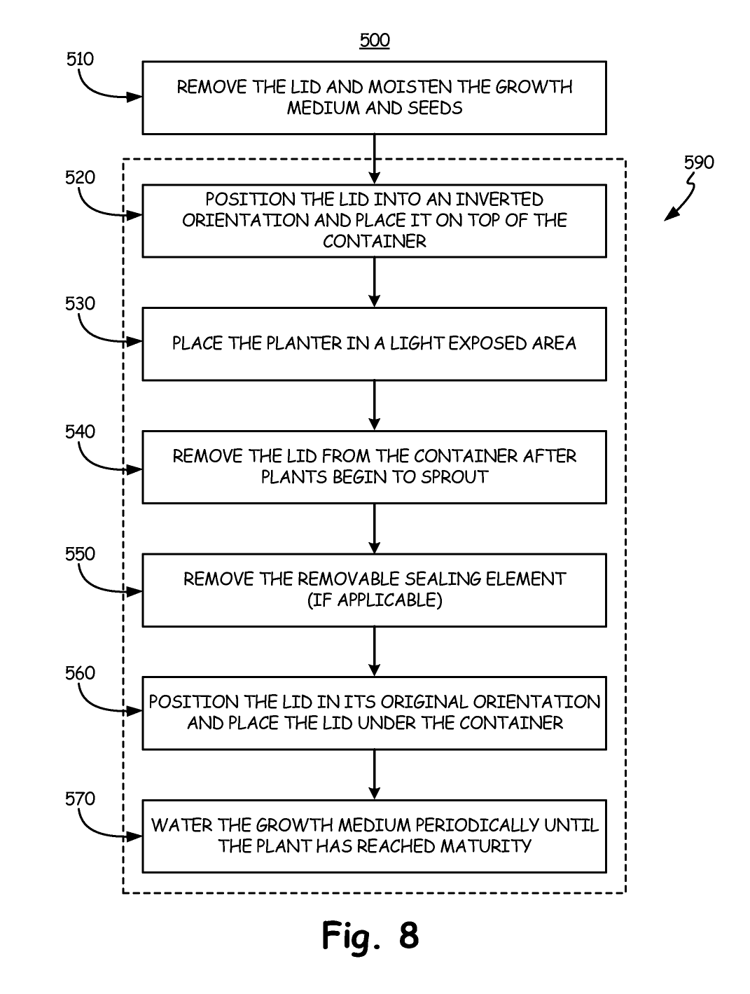

FIG. 8 is a flow chart providing the method of using the planter 10, in accordance to some embodiments. The planter 10 is used by first removing the lid 12 and moistening pre-seeded growth medium 16 with a predetermined amount of liquid (block 510). In some embodiments, the amount of water may be provided in a set of instruction accompanying the planter 10. The set of instructions may be provided in, but not limited to, a separate written pamphlet inserted within the product package, on a website, or on the packaging of the planter 10. The lid 12 is inverted relative to the pre-use configuration and placed back on top of the container 14 (block 520). The planter 10 is placed in a light exposed area (block 530). After plants begin to sprout, the lid 12 is removed from the container 14 (block 540) and, if applicable, the removable sealing element 58 is removed from a lower side 26 of a container 14 (block 550). In some embodiments, the lid 12 may be removed at a specified time frame corresponding to the set of instructions provided with the planter 10. The lid 12 is inverted relative to the greenhouse orientation and placed under the container 14 (block 560). In other words, the first face 44 of the lid 12 is coupled to the lower side 26 of the container 14, wherein one or more protrusions on the lid 12 and/or container 14 separate the plurality of drainage apertures from the lid 12 to allow egress of liquid from the container interior 30 onto the lid 12. The growth medium 16 is watered periodically until the plant reaches maturity (block 570). In some embodiments, the plant may be kept in the container 14 for the full plant life. In other embodiments, the user may remove the plant once it has reached a particular size.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

What is claimed is:

1. A planter comprising:
a lid; and
a container having an upper side, a lower side, and a plurality of lateral walls extending between the upper side and lower side, the upper side, lower side, and lateral walls defining a container interior configured to retain a growth medium, the upper side including an opening configured to provide access to the container interior, and the lower side including a plurality of drainage apertures, wherein one or more protrusions extend from at least one of a first face of the lid and an exterior of the lower side of the container,
wherein, in a greenhouse configuration, the lid is couplable to the upper side of the container to cover the opening such that the lid creates a greenhouse effect for sprouting seeds, and
wherein, in a drip-tray configuration, the lid is couplable to the lower side of the container such that the one or more protrusions separate the plurality of drainage apertures from the lid to allow egress of liquid from the container interior onto the lid.

2. The planter of claim 1, wherein, in a pre-use configuration, the lid is couplable to the upper side of the container such that a major face of the lid is more proximate to the lower side than in the greenhouse configuration to minimize the volume of the container interior.

3. The planter of claim 1, wherein at least a portion of the container comprises a recycled or recyclable plastic material.

4. The planter of claim 3, wherein at least approximately 50% of the container comprises recycled or recyclable plastic material.

5. The planter of claim 1, wherein at least one of the upper side and the lower side of the container is a substantially rectangular-shaped.

6. The planter of claim 1, wherein at least one of the upper side and the lower side of the container is substantially square-shaped.

7. The planter of claim 1, wherein the diameter of the one or more holes ranges from approximately 0.125″ to approximately 0.750″.

8. The planter of claim 1, further comprising a removable sealing element coupled to the exterior of the lower side of the container such that the plurality of drainage apertures are covered, wherein the removable sealing element prevent egress of any contents from the container interior.

9. The planter of claim 8, wherein the removable sealing element is an adhesive sheet.

10. The planter of claim 1, wherein a portion of the lid comprises recycled or recyclable plastic material.

11. The planter of claim 10, wherein the lid comprises at least approximately 30% recycled or recyclable plastic material.

12. The planter of claim 1, wherein the lid is comprised of a light-permeable material.

13. The planter of claim 1, wherein the lid is configured to have an interference and sealing fit with the upper side of the container.

14. The planter of claim 1, wherein the container is configured to retain pre-seeded growth medium in the form of a plant disk.

15. A method for using a planter, the planter including a light-permeable lid, and a container having an upper side, a lower side, and a plurality of lateral walls extending between the upper side and lower side, the upper side, lower side, and lateral walls defining a container interior that contains pre-seeded growth medium, the upper side including an opening configured to provide access the container interior, the lower side including a plurality of drainage apertures, and wherein, one or more protrusions extend from one of a first face of the lid and the exterior of the lower side of the container, the method for using the planter comprising:
removing the lid and moistening the pre-seeded growth medium with a predetermined amount of liquid;
placing the lid in a greenhouse orientation on top of the container;
placing the planter in a light exposed area;
removing the lid from the container after plants begin to sprout to a predetermined height;
coupling the first face of the lid to the lower side of the container in a drip tray orientation, wherein one or more protrusions on the lid and/or container separate the plurality of drainage apertures from the lid to allow egress of liquid from the container interior onto the lid; and
watering the pre-seeded growth medium periodically until the plants have reached maturity.

16. The method as defined in claim 15, wherein the predetermined height is between about 1 inch and about 1½ inches.

17. The method as defined in claim 15, wherein the container further comprises a removable sealing element coupled to an exterior of the lower side such that the plurality of drainage apertures are covered, and wherein the method further comprises:
removing the removable sealing element from the lower side of a container after the plants sprout to the predetermined height.
